(19) United States
(12) Patent Application Publication
(10) Pub. No.: US 2003/0142348 A1
(43) Pub. Date: Jul. 31, 2003

(54) Image forming system and image forming apparatus

(75) Inventors: Koji Hiramatsu, Toyokawa-Shi (JP); Tatsuya Eguchi, Toyohashi-Shi (JP)

Correspondence Address: Barry E. Bretschneider, Morrison & Foerster LLP, Suite 300, 1650 Tysons Boulevard, McLean, VA, 22102, US

(73) Assignee: Minolta Co., Ltd., Osaka-shi (JP)

(21) Appl. No.: 10/330,471

(22) Filed: Dec. 30, 2002

(30) Foreign Application Priority Data
Jan. 10, 2002 (JP) 2002-3805

(51) Int. Cl. G06F 15/00; B41J 1/00

(52) U.S. Cl. 358/1.15

(57) ABSTRACT

An image forming system includes a plurality of image forming apparatuses connected to a network, the plurality of image forming apparatuses including a first image forming apparatus and a second image forming apparatus. The image forming system includes a distributor which distributes an executing or waiting job registered in the first image forming apparatus into a first distributed job to be executed by the first image forming apparatus and a second distributed job to be executed by the second image forming apparatus, and a controller which makes the first and second image forming apparatuses execute the first and second distributed jobs distributed by the distributor.

Priority is claimed to Japanese Patent Application No. 2002-3805, filed on Jan. 10, 2002, the disclosure of which is incorporated by reference in its entirety.

### BACKGROUND OF THE INVENTION

1. Field of the Invention

The present invention relates to an image forming system in which a plurality of image forming apparatuses such as printers and copying machines are suitably used under a network environment, and also relates to an image forming apparatus.

2. Description of Related Art

It is well known that a plurality of image forming apparatuses such as printers used in companies or offices are systematically connected to a plurality of user personal computers via a network so that the users can share these image forming apparatuses. This system receives user's jobs via the personal computers in order and once stores the jobs in a memory portion, so that the jobs are executed in the order of receipt.

As a conventional image forming system applied to the network environment, for example, Japanese Unexamined Laid-open Patent Publication No. 2000-231465-A discloses the technique in which a print server which received a job asks another print server the job processing time and transfers the job to another print server in cases where another print server can complete the job earlier than the print server.

Furthermore, Japanese Unexamined Laid-open Patent Publication No. 2001-105691-A discloses the technique in which, if an error occurred in a printer which is executing job distribution processing, the printer makes another printer execute the processing and notifies the user of the substitute printer.

Now, in this kind of system, after sending a large quantity of copy/print job instructions to a certain image forming apparatus, a user sometimes realizes that another image forming apparatus is in a “free(available)” state. In this situation, if another image forming apparatus can share the job, the job processing time can be shortened.

However, in the aforementioned former prior technology, the entire job is merely transferred to another print server which can process more quickly, and a part of the registered job cannot be distributed to another image forming apparatus. Thus, the job processing time cannot be shortened.

On the other hand, according to the aforementioned latter prior technology, only the job subsequent to the error of the printer is executed by another printer, and therefore there is no guarantee that the subsequent job processing time can be shortened by the substitute processing.

### SUMMARY OF THE INVENTION

It is an object of the present invention to provide an image forming system and an image forming apparatus capable of shortening a job processing time required to complete the job by job distribution processing regardless of the job execution status or the job process waiting status.

According to the first aspect of the present invention, an image forming system includes a plurality of image forming apparatuses connected to a network, wherein the plurality of image forming apparatuses includes a first image forming apparatus and a second image forming apparatus. The image forming system comprises a distributor which distributes an executing or waiting job registered in the first image forming apparatus into a first distributed job to be executed by the first image forming apparatus and a second distributed job to be executed by the second image forming apparatus, and a controller which makes the first and second image forming apparatuses execute the first and second distributed jobs distributed by the distributor.

In this image forming system, the executing or waiting job registered in the first image forming apparatus connected to the network is distributed and executed by the first and second image forming apparatuses, respectively

In other words, after registering the job to the first image forming apparatus, if the user notices the “free(available)” state of the second image forming apparatus and instructs the second image forming apparatus to execute the job distribution execution together with the second image forming apparatus, even if the job is being executed or waited, the job will be distributed into the first and second image forming apparatuses and executed respectively and simultaneously. Accordingly, the processing time of the distributed jobs required to be completed can be shortened.

According to the second aspect of the present invention, an image forming apparatus includes a distributor which distributes an executing or waiting job registered in another image forming apparatus connected to a network into a job to be executed by the another image forming apparatus and a job to be executed by the image forming apparatus, and a controller which makes the image forming apparatus execute the job distributed to the image forming apparatus by the distributor.

In this image forming apparatus, after registering the job to the another Image forming apparatus, if the user notices the “free(available)” state of the image forming apparatus and instructs to execute the job distribution execution together with the image forming apparatus, even if the job is being executed or waited, the job will be distributed into both apparatuses and executed simultaneously. Accordingly, the processing time of the distributed jobs required to be completed can be shortened.

According to the third aspect of the present invention, an image forming apparatus capable of communicating with another image forming apparatus via a network, comprises a computing portion which computes a respective distribution amount of a job to be distributed into another image forming apparatus and the image forming apparatus, wherein the job is being executed or waiting in the another image forming apparatus, an operation portion which instructs an execution of the job distributed to the image forming apparatus by the computing portion, a receiver which receives a data regarding the job from another image forming apparatus, and a controller which executes the job distributed to the image forming apparatus in response to an operation of the operation portion.

In this image forming apparatus, after registering the job to another image forming apparatus, if the user notices the “free(available)” state of this image forming apparatus and instructs to execute the job distribution execution together with this image forming apparatus, the respective distribution amount of the job to be distributed into another image forming apparatus and this image forming apparatus is computed by the computing portion, wherein the job is being executed or waited in another image forming apparatus. When the user instructs the execution of the job distributed to this image forming apparatus, the receiver receives the data regarding the job, and the job distributed to this image forming apparatus is executed.

Other objects and the features will be apparent from the following detailed description of the present invention with reference to the attached drawings. The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims

### BRIEF DESCRIPTION OF THE DRAWINGS

The accompanying figures are provided by way of example, without limiting the broad scope of the invention or various other embodiments, wherein:

FIG. 1 is a schematic structural view showing an image forming system according to an embodiment of the present invention;

FIG. 2 is a block diagram showing the electrical structure of the image forming apparatus in the image forming system;

FIG. 3A shows a store table of a memory portion of a first image forming apparatus;

FIG. 3B shows a store table of a memory portion of a second image forming apparatus;

FIG. 4A shows a store table of the memory portion of the first image forming apparatus after changing into the distribution processing;

FIG. 4B shows a store table of the memory portion of the second image forming apparatus after changing into the distribution processing;

FIG. 5A is an explanatory drawing of the job execution status of the first and second image forming apparatuses before changing into distribution processing;

FIG. 5B is an explanatory drawing of the job execution status of the first and second image forming apparatuses after changing into distribution processing;

FIG. 6 shows a display screen showing a distribution proposal, etc., displayed on a display portion of the second image forming apparatus;

FIG. 7A shows a store table of the memory portion of the first image forming apparatus according to another distribution processing;

FIG. 7B shows the store table of the memory portion of the second image forming apparatus according to another distribution processing;

FIG. 8A shows the store table of the memory portion of the first image forming apparatus after changing into distribution processing according to another distribution processing;

FIG. 8B shows the store table of the memory portion of the second image forming apparatus after changing into distribution processing according to another distribution processing;

FIG. 9A is an explanatory drawing of the job execution status of the first and second image forming apparatuses before changing into distribution processing according to another distribution processing;

FIG. 9B is an explanatory drawing of the job execution status of the first and second image forming apparatuses after changing into distribution processing according to another distribution processing;

FIG. 10 is a flowchart showing the flow of distribution processing;

FIG. 11 is a schematic structural view-showing an image forming system according to another embodiment of the present invention;

FIG. 12 is a block diagram showing an electrical structure of an image forming apparatus according to the image forming system;

FIG. 13 is a sequence diagram showing the information transfer status of an example of job distribution processing; and

FIG. 14 is a sequence diagram showing the information transfer status of an another example of job distribution processing.

### DETAILED DESCRIPTION OF THE PREFERRED EMBODIMENTS

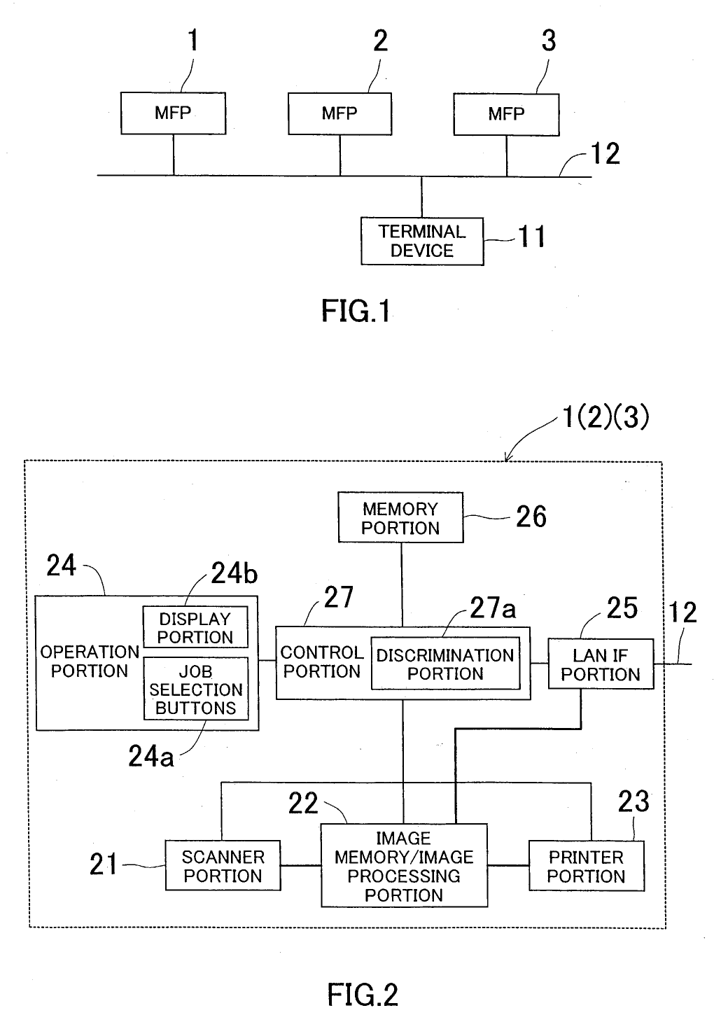

FIG. 1 is a schematic structural view showing an image forming system according to an embodiment of the present invention.

The image forming system shown in FIG. 1 includes a plurality of image forming apparatuses 1, 2 and 3 and a user terminal device 11. These image forming apparatuses 1, 2 and 3 and the terminal device 11 are connected via a network such as an LAN (Local Area Network) 12.

The aforementioned image forming apparatus 1, 2 and 3 may be a copying machine, a facsimile machine (FAX), a printer, a scanner, etc. In this embodiment, a multi function peripheral (hereinafter “MFP”) having functions such as a copying machine, a facsimile machine, a printer, a scanner, etc., is exemplified.

These MFPs 1, 2 and 3 can mutually exchange image data or control data via the LAN.

Although the terminal device 11 is constituted by, for example, a personal computer (hereinafter may also referred to as “PC”), it is not limited to a PC.

FIG. 2 is a block diagram showing the electrical structure of the MFP 1 representing the MFP 1, 2 and 3.

In FIG. 2, the MFP 1 is equipped with a scanner portion 21, an image memory/image processing portion 22, a printer portion 23, an operation portion 24, an LAN interface (LAN IF) portion 25, a memory portion 26 and a control portion 27.

The scanner portion 21 scans an image of an original disposed on a predetermined portion of an original stage, and converts it into an image data.

The image memory/image processing portion 22 once stores the read original image or the image data received via the LAN interface portion 25, and executes predetermined image processing, and the printer portion 23 prints out the image processed data.

The operation portion 24 is used to set and check a copy mode and instruct a job execution or distribution processing in accordance with a user's operation such as a copy start operation, and is provided with an operation button portion including job selection buttons 24a and a display portion 24b including an LCD for displaying the contents of the operation input, the job information, etc. The job selection buttons 24a are used to select a certain job to be distributed among the jobs displayed on the display portion 24b.

The LAN interface portion 25 exchanges the image data and/or the control data between the MFP 1 and external apparatuses such as the other MFP 2 (3) and the PC 11.

The memory portion 26 registers a job to be executed, more concretely stores the job contents and various data and updates/stores the job execution status in order.

The control portion 27 organically controls each portion and has a function as a discrimination portion 27a which discriminates whether it is possible to execute the distribution processing of the job stored and registered in the memory portion 26 together with another secondary MFP 2 (3), or which discriminates whether it is possible to execute the distribution processing of the job stored and registered in another MFP 2 (3) together with this MFP 1. Furthermore, the control portion 27 has a function for creating a distribution processing proposal which can execute the job to be distributed in the shortest time, a function for displaying the proposal on the display portion 24b when it is discriminated that it is possible to execute the registered job distribution processing and a function for executing the processing the job to be distributed based on the distribution processing proposal together with the secondary MFP 2 (3).

In the aforementioned image forming system, in cases where a user copies an original image using the MFP 1, when the user presses the start button of the operation portion 24 in the copy mode in which job processing conditions, etc., are set, the original image is read by the scanner portion 21, and the read image signal is converted into an image data.

The predetermined processing of the image data is executed by the image memory/image processing portion 22, and then the processed image data is printed on a paper by the printer portion 23 according to the set print conditions.

At this time, the control portion 27 controls the series of operations of each portion, and the memory portion 26 stores the job and also stores the copy mode and the processing status while updating them.

Furthermore, in cases where a user uses the MFP 1 as a printer, the image data transmitted by the user via the PC 11 and the printing mode thereof are inputted into the MFP 1 via the LAN I/F portion 25. Then, the image data is processed by the image memory/image processing portion 22 in accordance with the obtained printing mode, and thereafter printed on a paper by the printer portion 23 according to the set printing conditions.

At this time too, the control portion 27 controls the series of operations of each portion, and the memory portion 26 stores the job and also stores the copy mode and the processing status while updating them.

Next, the job distribution processing by the image forming system will be explained.

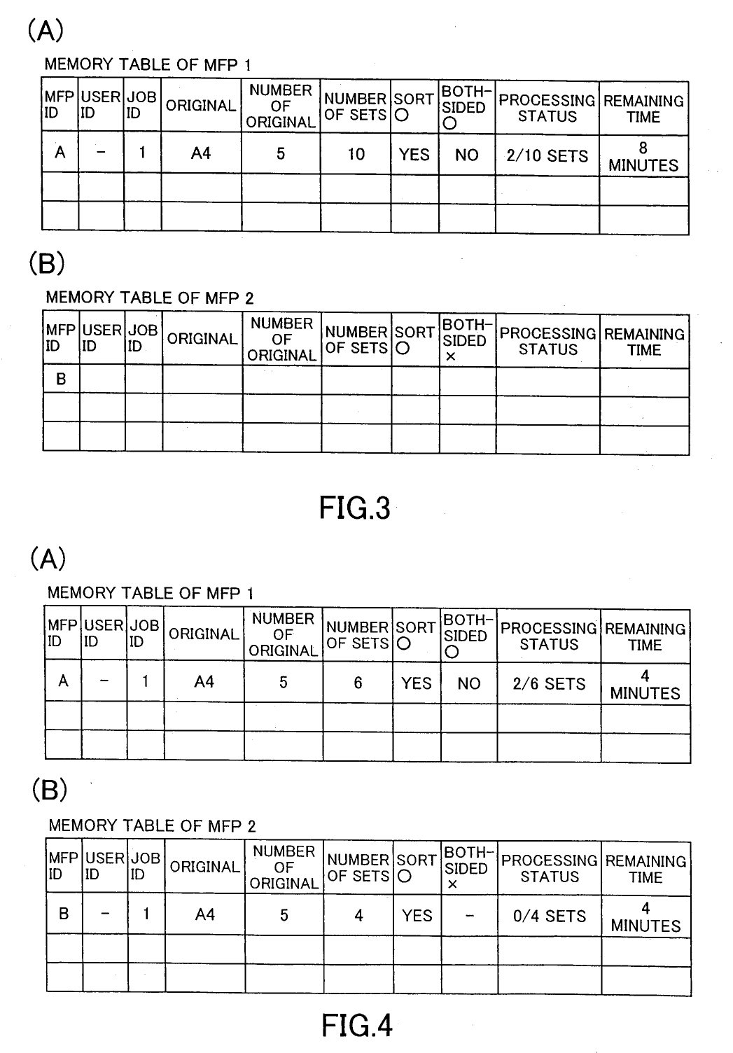

It is assumed that a user performs a copy of an original image by using the MFP 1. If the user sets the copy mode as “obtaining 10 sets of copies from 5 sheets of A4 originals using a sort function” as shown in FIG. 3A via the operation portion 24 of the MFP 1 and thereafter gives a start instruction (presses the start button), the copy operation by the MFP 1 starts.

It is further assumed that, during the copying operation of the MFP 1, the user leaves the MFP 1 and approaches another MFP 2 to find that the MFP 2 is currently in “free(available)” state and tries to execute the job distribution processing together with the “free(available) ” MFP 2 in order to shorten the copy processing time.

First, the user inputs a discrimination (ID) information (in this embodiment, ID=A), which is peculiar to the MFP 1, via the operation portion 24 of the MFP 2 in order to utilize the MFP 2. Then, the MFP 2 inquires whether there is any executing job or waiting job to the MFP 1 via the IF portion 25 by the control of the control portion 27.

To this inquiry, the MFP 1 notifies the MFP 2 of the stored contents of the memory portion 26, i.e., the table information shown in FIG. 3A via the LAN interface portion 25.

According to this table information, the user can recognize that the MFP 1 is currently executing the second set of copies among the job of “obtaining 10 sets of copies from 5 sheets of A4 originals using a sort function” and the remaining processing time is 8 minutes with no reservation job.

The MFP 2 displays the job list of the received table information on the display portion 24b of the operation portion 24 in accordance with the directions of the control portion 27. This enables the user to easily recognize that the displayed job is the job instructed by himself/herself.

If the user intends to subject his/her own job to distribution processing, the user selects the job as a job to be distributed via the job selection button 24a of the MFP 2. In response to this selection, the discrimination portion 27a in the MFP 2 discriminates whether the job can be performed by the distribution processing.

The current job which is being executed in the MFP 1 is a job using a sort function. The MFP 2 has a sort function as shown by “◯” in the memory table of FIG. 3B although it does not have a double-sided copy function as shown by “X” in the memory table. Therefore, the MFP 2 can execute the distribution processing of the job.

Now, the table information of FIG. 3A shows that the MFP 1 is currently executing the second set of copying, and the table information on FIG. 3B shows that the MFP 2 has no job reservation.

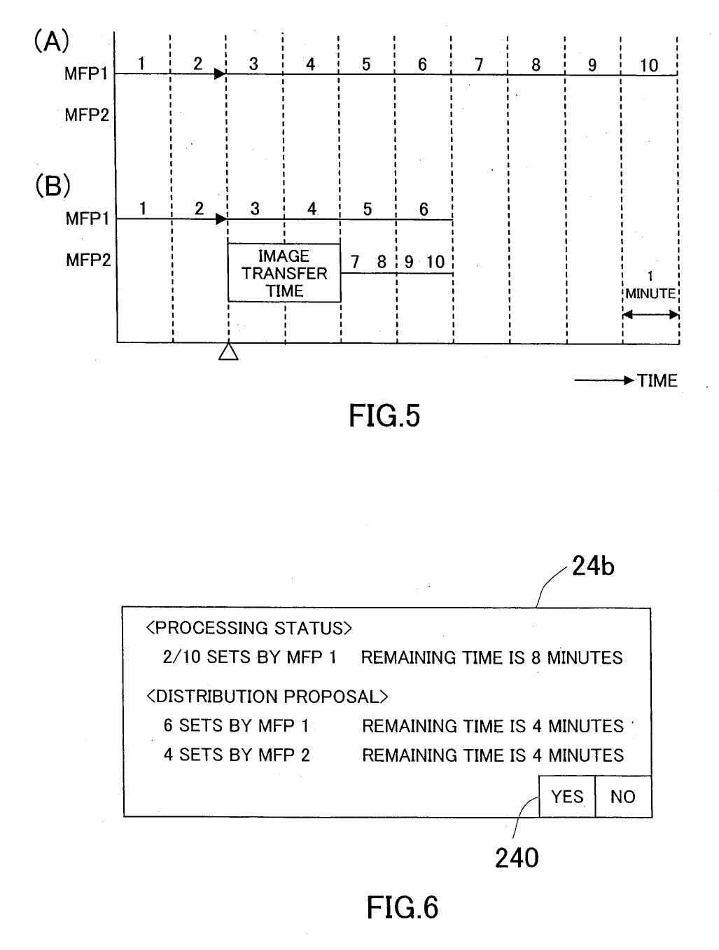

Next, the job processing status will be explained with reference to FIG. 5.

Before the distribution processing, as shown in FIG. 5A, the MFP 1 is currently (at the time of “Δ”) executing the second set of copying, 8 minutes will be required to complete the tenth set of copying, and the MFP 2 is in the “free(available)” state in which no job is being processed. In this embodiment, it is assumed that the MFP 2 has a processing speed twice as that of the MFP 1.

When the MFP 2 receives an instruction for distribution processing, the MFP 2 examines a distribution method by which the current job which is being executed by MFP 1 can be terminated in the shortest processing time based on the status shown in FIG. 3A. The table information includes information on the job image memory capacity, the processing speed, etc., and therefore the transfer time and/or the printout time can be calculated.

Concretely, it is assumed that the control portion 27 of the MFP 2 calculates based on the table information obtained from the MFP 1 such that it takes 2 minutes to transfer the image data of the job and the job to be subjected to the distribution processing from the MFP 1 to the MFP 2 and it takes 30 seconds to printout one set of copying.

From this calculation results, the distribution processing proposal which can terminate the job in the shortest time from the transfer start time is shown in FIG. 5B. In this proposal, the job can be completed in the next four minutes if the MFP 1 executes the processing of four sets of copying including third to sixth sets of copying in addition to the currently executing second set of copying and the MFP 2 executes the processing of four sets of copying including seventh to tenth sets of copying. Then, the control portion 27 of the MFP 2 displays the distribution processing proposal on the display portion 24b as shown in FIG. 6. The display screen shows determination buttons 240 for selecting the distribution selection instruction (YES) or the distribution non-selection instruction (NO).

If the user who saw the distribution processing proposal displayed on the display portion 24b of the MFP 2 determines the execution of the distribution processing (i.e., if the user touches “YES”), the distribution processing proposal is transferred from the MFP 2 to the MFP 1, and the distribution processing is also executed in this MFP 2.

Thus, even in cases where the job is being executed in the first MFP 1, if it is discriminated that the distribution processing of the job can be executed in the MFP 2 which is in the “free(available)” state, the job for the distribution processing is executed not only by the first MFP 1 but also by the second MFP 2. Therefore, the entire job can be completed quickly.

When executing the distribution processing of the job, the table information in the memory portion 26 of the MFP 1 is updated/stored in the state corresponding to the distribution processing proposal as shown in FIG. 4A, and furthermore the table information in the memory portion 26 of the MFP 2 is also updated/stored in the state corresponding to the distribution processing proposal shown in FIG. 4B.

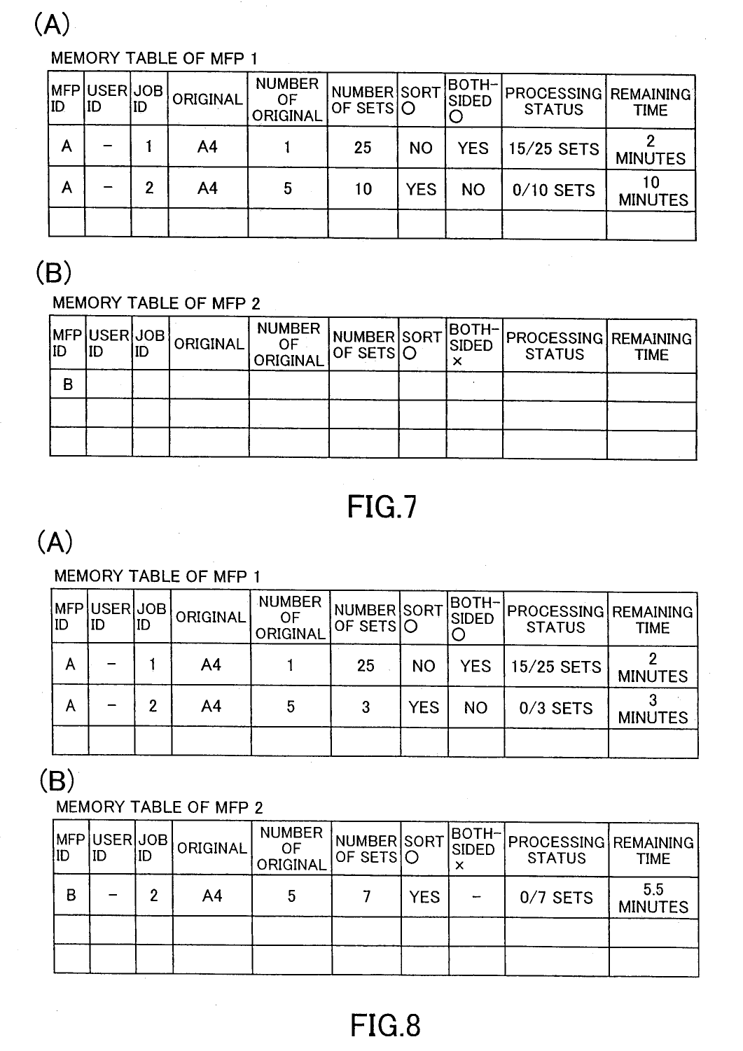

Next, an example in which a job waiting in the MFP 1 is subjected to distribution processing by another MFP 2 will be explained with reference to FIGS. 7 to 9.

In this example, it is assumed that a user reserves a copy using the MFP 1 which is executing a certain job and sets the copy mode as “obtaining 10 sets of copies from 5 sheets of A4 originals using a sort function” as shown in FIG. 7A.

When the instruction of this copy mode is received by the MFP 1, the reservation copy operation starts in accordance with the start instruction by the user (i.e., pressing the start button).

It is assumed that the user leaves the MFP 1 and approaches another MFP 2 to find that the MFP 2 is currently in the “free(available)” state and tries to execute distribution processing of the job reserved in the MFP 1 with the “free(available)” MFP 2.

First, the user inputs the discrimination (ID) of the MFP 1 (in this embodiment, ID=A) via the operation portion 24 of the MFP 2 in order to utilize the MFP 2. Then, the MFP 2 inquires to the MFP 1 whether there is any executing job or waiting job via the IF portion 25.

To this inquiry, the MFP 1 reads out the stored contents of the memory portion 26, i.e., the table information shown in FIG. 7A, and notifies the MFP 2 of the information via the IF portion 25. According to this table information, the user can recognize that the MFP 1 is currently executing the job of “25 sets of copies from one A4 original,” the remaining processing time is 2 minutes and the MFP 1 has a reservation for the job 2 (job ID=2) subsequent to the aforementioned job.

The MFP 2 displays the job list of the received table information on the display portion 24b of the operation portion 24 in accordance with the instruction of the control portion 27. This enables the user to easily recognize that the displayed job is the job reserved by himself/herself.

Since the user intends to subject the job 2 to distribution processing, the user selects the job 2 as a job to be distributed via the job selection button 24a of the MFP 2. In response to this selection, the discrimination portion 27a in the MFP 2 discriminates whether the job can be performed by distribution processing.

Although the MFP 2 does not have a both-sided copy function as shown by “X” in the table of FIG. 7B, but has a sort function as shown by “◯”. The job 2 to be subjected to distribution processing is a job which only uses a sort function, as shown in the table of FIG. 7A. Therefore, it is discriminated that the distribution processing using this MFP 2 is possible.

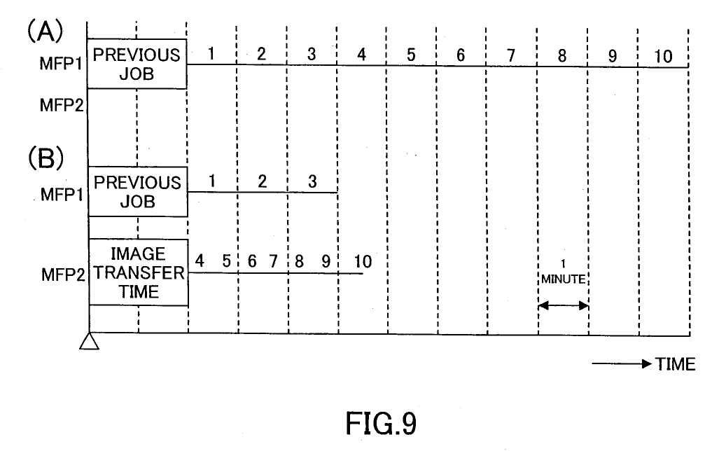

Next, the job processing status will be explained with reference to FIG. 9.

FIG. 9A shows that the MFP 1 is currently (at the time of “Δ” in FIG. 9A) executing the previous job 1, two minutes will be required to complete the job 1 and thereafter ten minutes will be required to complete the job 2. Furthermore, FIG. 9A shows that the MFP 2 is in the “free(available)” state in which no processing is currently being executed.

The control portion 27 of the MFP 2 creates a distribution processing proposal which can execute the job 2 in the shortest processing time based on the contents of the memory table shown in FIG. 7A. It is assumed that the control portion 27 of the MFP 2 calculates based on the table information obtained from the memory table of the MFP 1 such that it takes 2 minutes to transfer the image data of the job 2 and it takes 30 seconds to printout one set of copies (the MFP 2 has a processing speed twice as fast as the MFP 1).

As a result, the distribution processing proposal which can complete the job 2 from the current status in the shortest processing time is shown in FIG. 9B. In other words, the proposal shows that it is appropriate that the MFP 1 executes three sets of copies and the MFP 2 executes the remaining seven sets of copies and that the processing can be completed in five minutes and thirty seconds. At this time, the image transfer from the MFP 1 to the MFP 2 is carried out while executing the previous job 1 by the MFP 1.

Then, the MFP 2 displays this distribution processing proposal on the display portion 2b. When the user looks at the distribution processing proposal displayed on the display portion 24b and selects the distributed execution, the distribution processing proposal is transferred from the MFP 2 to the MFP 1, while the MFP 2 executes the job to be distributed.

As will be apparent from the above, even in cases where the MFP 1 has a waiting job, if it is discriminated that the distribution processing of the job can be executed by the MFP 2 which is currently in the “free(available)” state, the processing of the job to be distributed can be executed not only by the MFP 1 but also by the MFP 2. Accordingly, the job can be completed quickly. Furthermore, the job execution efficiency is high because the job is processed based on the optimal distribution processing proposal.

When executing the distribution processing, the processing contents shown in FIG. 8A corresponding to the distribution processing proposal are stored in the storing portion 26 of the MFP 1 as a table. Furthermore, the processing contents shown in FIG. 8B corresponding to the distribution processing proposal are also stored in the storing portion 26 of MFP 2 as a table.

The former example shown in FIGS. 3 to 5 is directed to the distribution processing of the job 1 in the case where the MFP 2 is in the “free(available)” state when the MFP 1 is executing the distribution processing of the job 1. The latter example shown in FIGS. 7 to 9 is directed to the distribution processing of the job 2 in the case where the MFP 2 is in the “free(available)” state when the MFP 1 is executing the previous job 1. However, the present invention is not limited to the above, and the same effects can be demonstrated by applying distribution processing so long as it is discriminated that it is possible to execute job distribution processing in various job processing statuses.

Furthermore, in the aforementioned examples, although the distribution processing is performed on the basis of a sort copy, the distribution processing may be performed on the basis of, for example, the number of originals. For example, in the case of making one copy of each of 100 sheets of original images, it is possible to make the MFP 1 copy from the 1^{st} to 60^{th} sheet of the original images and to make the MFP 2 copy from the 61^{st} to 100^{th} sheet of the original images.

Furthermore, although the ID information of the MFP 1 is inputted at the time of searching or instructing the job, the job search or instruction may be performed by using the job registration user identification information (hereinafter referred to as “user ID information”) or the job identification information (hereinafter referred to as “job ID information”).

For example, if the user ID information is inputted at the time of giving the copy instruction via the MFP 1, the user ID will also be stored in the memory table of the MFP 1 shown in FIG. 3A in connection with the job. Accordingly, in the MFP 2, if the user ID information is inputted, the job corresponding to the user ID will be displayed. Therefore, the job to be distributed may be selected via the display, and the user can easily discriminate the job registered by himself/herself.

Furthermore, at the time of giving a copy instruction via the MFP 1, if the MFP 1 shows the job ID to the user, the user can input the job ID to specify the job in the MFP 2.

Furthermore, this is not limited to the case in which a copy instruction is given from the MFP 1, but may also be applied to the case in which a print instruction of an image data is given from the PC 11. For example, if the user approaches the MFP 2 and inputs the ID information of MFP 1/the user ID information/the job ID information after giving a print instruction from the PC 11 to the MFP 1, the user can specify the job to be subjected to distribution processing and executes the distribution processing.

Furthermore, in the aforementioned embodiment, the job instruction/the job distribution execution instruction was given via the operation portion 24 of the MFP 2 which performs additional distribution processing. However, the distributed execution instruction may be given via the operation portion 24 of the MFP 1 having the job.

For example, it may be constituted such that a distribution proposal of the MFP 1 and the MFP 2 is displayed on the operation portion 24 of the MFP 1 when the job to be distributed is specified by the operation portion 24 of the MFP 1 and the ID information of the MFP 2 performing the distribution processing is inputted.

Furthermore, similarly, it is also possible for the user to execute distribution processing by the MFP 1, the MFP 2 and the MFP 3 using the ID information/the user ID information/the MFP ID information when the user who instructed the distributed execution of the MFP 1 and the MFP 2 at the MFP 2 side approaches another MFP3. In this case, the distribution proposal will be considered based on the memory table information shown in FIGS. 4 and 8.

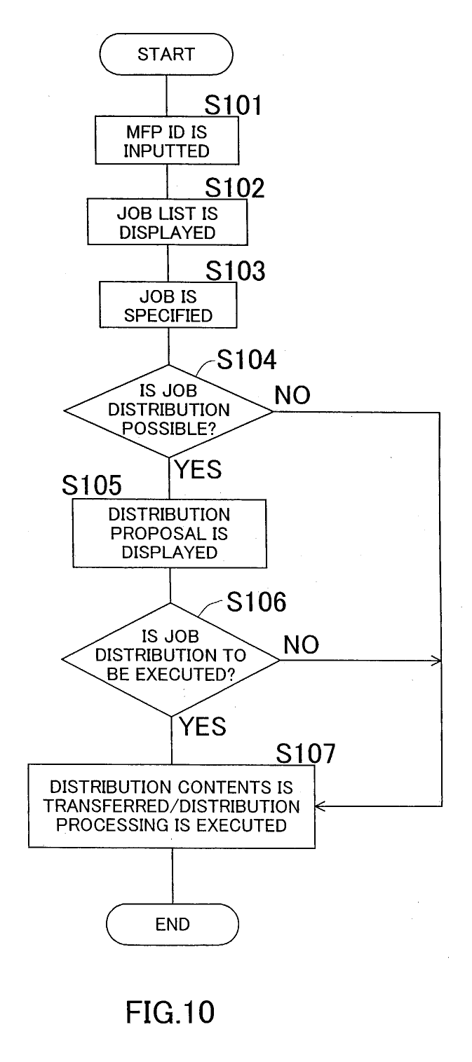

Next, the flow of the distribution processing in the image forming system will be explained with reference to the flowchart shown in FIG. 10.

For example, in cases where the user of a job which is being executed or waiting at the MFP 1 intends to perform the job distribution processing when the user approaches the MFP 2, if the user inputs the ID information such as the ID information of the MFP 1 to the MFP 2, the control portion 27 of the MFP 2 recognizes this in S101. Thereafter, in S102, the control portion 27 displays the list of the jobs on the display portion 24b of the MFP 2 into which the ID information was inputted.

When the user looks-at the display of the aforementioned job list and selects/instructs his/her own job as the job to be distributed, this will be recognized by the control portion 27 in S103.

In response to this instruction, in S104, the discrimination portion 27a of the MFP 2 discriminates whether it is possible for the job to be subjected to distribution processing. If it is possible to do so (Yes in S104), in S105, a distributed proposal is displayed on the display portion 24b of the MFP 2, and the routine proceeds to S106. To the contrary, if the distribution processing is impossible (No in S105), the routine ends as it is.

In S106, the control portion 27 of the MFP 2 discriminates whether distribution processing of the job is to be executed based on the operation of the determination button 240 by the user. If the job distribution processing is to be executed (Yes in S106), the routine proceeds to S107. To the contrary, if the job distribution processing is not to be executed (No in S106), the routine ends as it is.

In S107, the distribution processing proposal is transferred to the MFP 1 from the MFP 2, and the distribution processing in the MFP 2 will be terminated.

Next, another embodiment of the present invention will be explained with referring to the attached drawings.

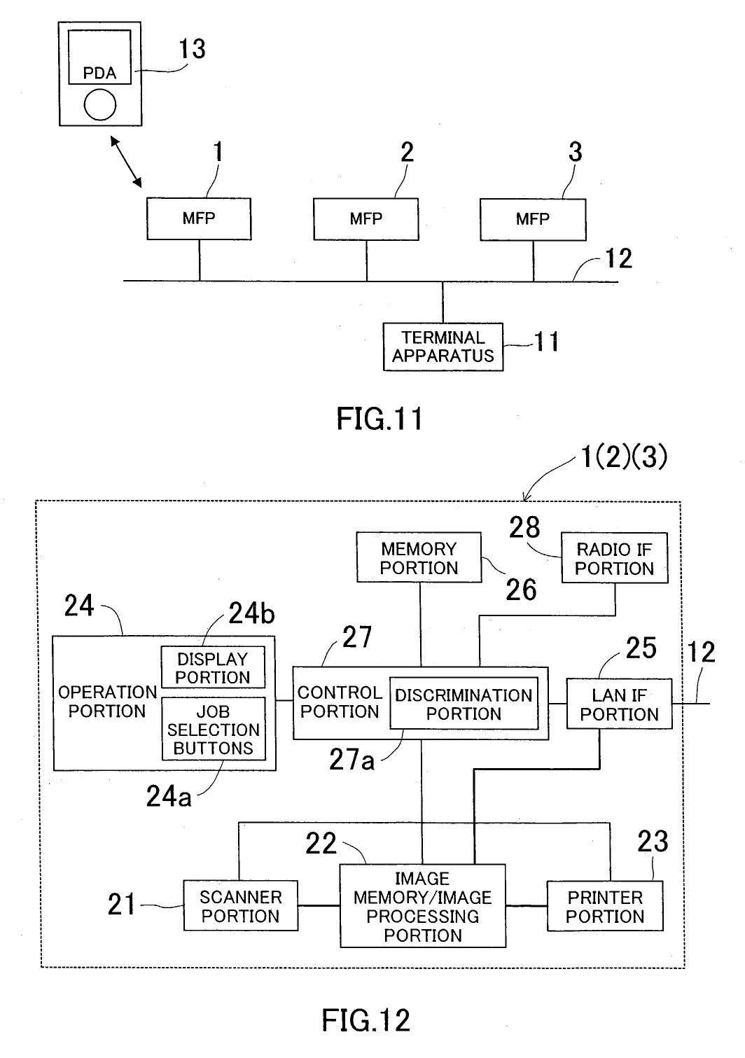

FIG. 11 is a schematic structural view showing an image forming system according to another embodiment of the present invention, and FIG. 12 is a block diagram showing an electrical structure of the MFP 1 representing the MFP 1, the MFP 2 and the MFP 3. A portable terminal 13 is added in FIG. 11, and a radio interface portion (radio IF portion) is added in FIG. 12. Since the other structures other than the above are the same as those shown in FIGS. 1 and 2, their explanations will be omitted by allotting the same reference numerals.

In FIG. 11, the reference numeral 13 denotes a user's portable terminal such as a PDA (Personal Digital Assistant) which can communicate with the MFP 1, 2, 3 . . . within a certain range of communication area. This portable terminal 13 has an ID information peculiar to a user, and transmits the ID information to the MFP 1, 2, 3 . . . via a non-contacting system such as a radio system when the ID information is required by the MFP 1, 2, 3 . . .

The portable terminal 13 is not limited to the above, and may be a mobile device including IC cards of various systems and cellular phones.

In FIG. 12, the reference numeral 28 denotes a radio interface portion with a communication control function constituting a PAN (Personal Area Network) together with the portable terminal 13, which corresponds to an IrDA using infrared radiation (Infrared Data Association) or a Bluetooth using short-distance radio.

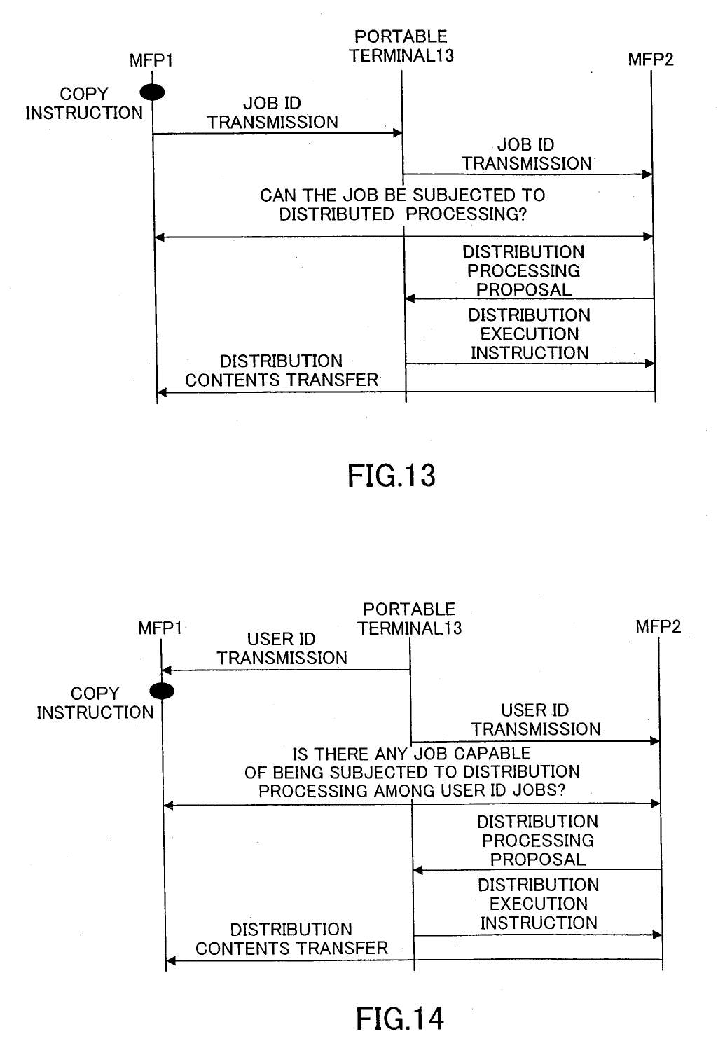

Next, the job distribution processing using the aforementioned portable terminal 13 will be explained with reference to FIGS. 13 and 14.

FIG. 13 is a sequence diagram showing an example in which job distribution processing is executed using job ID information.

When a user having the portable terminal 13 sets a copy mode instruction via the operation portion 24 of the MFP 1, the job is registered.

After the completion of the job registration, the MFP 1 transmits the job ID information to the portable terminal 13, and the portable terminal 13 receives and stores this job ID information.

Subsequently, when the user having the portable terminal 13 approaches the MFP 2, the portable terminal 13 enters the communication area and transmits the stored job ID information automatically.

The MFP 2 searches and specifies a job corresponding to the received job ID information as a waiting or executing job on the network 12 by the control portion 27, and further discriminates by the discrimination portion 27a whether the specified job can be subjected to distribution processing.

If it is discriminated that the job can be subjected to distribution processing, the MFP 2 transmits a distribution processing proposal to the portable terminal 13, and the portable terminal 13 received this proposal displays the distribution processing proposal.

When the user instructs the execution of the distribution processing based on the proposal, the MFP 2 which received the instruction transmits the processing contents distributed and changed to the MFP 1. Then, the MFP 1 and the MFP 2 execute the distribution processing.

FIG. 14 is a sequence diagram of an example in which job distribution processing is executed using user ID information instead of job ID information.

When a user having a portable terminal 13 approaches the MFP 1 and enters the area in which the portable terminal 13 can communicate with the MFP 1, the MFP 1 requires the portable terminal 13 to send the user ID information, and thus the user ID information sent from the portable terminal 13 is received by the MFP 1. In this stage, if the user instructs the MFP 1 to perform a copy via the operation portion 24 thereof, the job is received in the state in which the job is related with the obtained user ID information.

Next, after leaving the MFP 1, when the user having the portable terminal 13 approaches the MFP 2 and therefore the portable terminal 13 enters the area in which the portable terminal 13 can communicates with the MFP 2, the MFP 2 automatically receives the user ID information from the portable terminal 13.

The MFP 2 searches and specifies a job corresponding to the received user ID information as a waiting or executing job on the network 15 by the control portion 27, and further discriminates by the discrimination portion 27a whether the specified job can be subjected to distribution processing.

If it is discriminated that the job can be subjected to distribution processing, the MFP 2 transmits a distribution processing proposal to the portable terminal 13, and the portable terminal 13 received this proposal displays the distribution processing proposal. When the user instructs the execution of the distribution processing based on the proposal on the portable terminal 13, the MFP 2 which received the instruction transmits the processing contents distributed and changed to the MFP 1. Then, the MFP 1 and the MFP 2 execute the distribution processing.

In this case, the user having the portable terminal 13 can immediately obtain the information on the possibility of distribution processing by simply approaching the MFP 2, and therefore can quickly send the following instructions.

In the aforementioned embodiment, the job distribution processing proposal is transmitted to the portable terminal 13 from the MFP 2, and the distributed execution instruction is transmitted to the MFP 2 from the portable terminal 13. However, since the user having the portable terminal 13 is near the MFP 2, the MFP 2 may notify the user of the creation of distribution processing proposal by audible tone, etc., and the proposal may be displayed on the display portion 24b of the MFP 2.

Furthermore, if it is constituted such that the job mode is exchanged between the MFP 1, MFP 2 and the portable terminal 13 in addition to the job ID information, it is possible to immediately discriminate whether the job can be subjected to distribution processing even if the MFP 2 does not confirm it to the MFP 1.

If the portable terminal 13 has received the job mode information on the sort function/double-sided copy function of the target job from the MFP 1, the MFP 2 can discriminate whether it is the job which can be distributed when the information received from the portable terminal 13.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive.

What is claimed is:

1. An image forming system including a plurality of image forming apparatuses connected to a network, said plurality of image forming apparatuses including a first image forming apparatus and a second image forming apparatus, said image forming system, comprising:
a distributor which distributes an executing or waiting job registered in said first image forming apparatus into a first distributed job to be executed by said first image forming apparatus and a second distributed job to be executed by said second image forming apparatus; and
a controller which makes said first and second image forming apparatuses execute said first and second distributed jobs distributed by said distributor.

2. The image forming system as recited in claim 1, wherein said second image forming apparatus includes a display portion, an operation portion which makes said display portion display the executing or waiting job registered in said first image forming apparatus by input operations and a selector which selects a job to be distributed among jobs displayed on said display portion.

3. The image forming system as recited in claim 1, further comprising a user portable terminal capable of communicating with said first and second image forming apparatuses in their communication area,
wherein said portable terminal is provided with a transmitter which transmits job discrimination information corresponding to a job obtained in accordance with a registration of the job to said first image forming apparatus or transmits job registration user discrimination information to said second image forming apparatus in a communication area of said second image forming apparatus, and
wherein said second image forming apparatus specifies a job to be distributed based on the discrimination information transmitted.

4. The image forming system as recited in claim 1, wherein said distributor proposes a distribution of a job so that processing of the job can be terminated in the shortest time.

5. An image forming apparatus, comprising:
a distributor which distributes an executing or waiting job registered in another image forming apparatus connected to a network into a job to be executed by said another image forming apparatus and a job to be executed by said image forming apparatus; and
a controller which makes said image forming apparatus execute the job distributed to said image forming apparatus by said distributor.

6. The image forming system as recited in claim 5, further comprising a display portion, an operation portion which makes said display portion display the executing or waiting job registered in said image forming apparatus by input operations and a selector which selects a job to be distributed among jobs displayed on said display portion.

7. The image forming system as recited in claim 5, wherein said distributor proposes a distribution of a job so that processing of the job can be terminated in the shortest time.

8. An image forming apparatus capable of communicate with another image forming apparatus via a network, said image forming apparatus, comprising:
a computing portion which computes a respective distribution amount of a job to be distributed into said another image forming apparatus and said image forming apparatus, wherein the job is being executed or waiting in said another image forming apparatus;
an operation portion which instructs an execution of the job distributed to said image forming apparatus by said computing portion;
a receiver which receives a data regarding the job from said another image forming apparatus; and
a controller which executes the job distributed to said image forming apparatus in response to an operation-of said operation portion.

9. The image forming apparatus according to claim 8, further comprising a display portion which displays said distribution amount of job of said another image forming apparatus and said image forming apparatus computed by said computing portion.

10. The image forming apparatus according to claim 8, further comprising a selector which selects a job to be distributed among a plurality of jobs which are being executed or waiting in said another image forming apparatus.

11. The image forming apparatus according to claim 8, further comprising a display portion which displays a processing status of the job in said another image forming apparatus obtained from said another image forming apparatus.

12. The image forming apparatus according to claim 8, wherein said computing portion distributes the job so that an output of the job can be completed in the shortest time.

13. The image forming apparatus according to claim 8, wherein said image forming apparatus is a multi function peripheral equipped with a plurality of functions including a copying function and a printing function.
